(19) United States
(12) Patent Application Publication
(10) Pub. No.: US 2018/0057730 A1
(43) Pub. Date: Mar. 1, 2018

(54) COMPOSITION AND METHOD FOR CEMENTING IN SUBTERRANEAN FORMATIONS USING INORGANIC FIBERS

(71) Applicant: BAKER HUGHES, A GE COMPANY, LLC, Houston, TX (US)

(72) Inventors: TERRY D. MONROE, TOMBALL, TX (US); SUMIT BHADURI, THE WOODLANDS, TX (US); VIRGILIO C. GO BONCAN, SPRING, TX (US); CHRISTINA MAGELKY, SPRING, TX (US)

(73) Assignee: BAKER HUGHES, A GE COMPANY, LLC, HOUSTON, TX (US)

(21) Appl. No.: 15/683,628

(22) Filed: Aug. 22, 2017

Related U.S. Application Data
(60) Provisional application No. 62/380,115, filed on Aug. 26, 2016.

(51) Int. Cl. C09K 8/467; C04B 28/02; C04B 14/46

(52) U.S. Cl. CPC C09K 8/467; C04B 28/02; C04B 2201/50; C09K 2208/08; C04B 14/46

(57) ABSTRACT

Various illustrative embodiments of a cement composition for use in subterranean formations are disclosed. The cement composition can comprise water and cement. The cement powder can be mixed with water on-site to create a cement slurry or mixed with water off-site and transported to the well site. The cement composition can be pumped into the subterranean formation and allowed to penetrate the formation. For example, the cement slurry can be pumped into the wellbore, such as into the annulus, to displace fluids in the wellbore and replace them with cement.

### RELATED APPLICATIONS

This application claims the benefit, and priority benefit, of U.S. Provisional Patent Application Ser. No. 62/380,115, filed Aug. 26, 2016, the disclosure and contents of which are incorporated by reference herein in their entirety.

### FIELD OF THE INVENTION

The presently disclosed subject matter relates to a cement composition containing inorganic fibers and use of the cement composition for oil and gas applications.

### BACKGROUND

It is known in the art to use cement to seal a wellbore in an oil and gas well. For example, cement can be placed in the annulus between the outside surface of a pipe string and the inside wall of a wellbore to seal off fluid flow. Cementing can also be used to plug portions of a well or to seal lost circulation zones. Improvements in this field of technology are desired.

### SUMMARY

Various illustrative embodiments of a method of cementing an oil and gas well in a subterranean formation are provided. In certain illustrative embodiments, a cementing composition can be injected into the subterranean formation. The cementing composition can include water, a cement and inorganic fibers. The cementing composition can be distributed within the subterranean formation. The cementing composition can have an increased tensile strength after the inorganic fibers are added to the cementing composition. The inorganic fibers can include mineral wool fibers.

Various illustrative embodiments of a method of enhancing the tensile strength of a cementing composition introduced into a subterranean formation are also provided. In certain illustrative embodiments, inorganic fibers can be added to the cementing composition. The cementing composition can also include water and a cement. The cementing composition can be introduced into the subterranean formation. The inorganic fibers can include mineral wool fibers.

Various illustrative embodiments of a cement composition for use in a subterranean formation are also provided. In certain illustrative embodiments, the cement composition can include water, cement and inorganic fibers. The inorganic fibers can include mineral wool fibers.

### DETAILED DESCRIPTION

Disclosed herein are various illustrative embodiments of a cement composition for use in subterranean formations. In certain illustrative embodiments, the cement composition can comprise water and cement. For example, cement powder may be mixed with water on-site to create a cement slurry or mixed with water off-site and transported to the well site. The cement composition can be pumped into the subterranean formation and allowed to penetrate the formation. For example, the cement slurry can be pumped into the wellbore, such as into the annulus, to displace fluids in the wellbore and replace them with cement.

In certain illustrative embodiments, the cement composition can also include inorganic fibers. In an illustrative embodiment, the inorganic fibers can comprise mineral wool fibers. Mineral wool fibers typically are produced from inorganic materials such as igneous rock (diabase, basalt or olivine) and blast furnace slag from the steel industry. Mineral wool fibers are an inert, non-damaging material towards the environment with an LC-50 of one million. In certain illustrative embodiments, the mineral wool fibers are acid-soluble and thermally stable at temperatures up to 1,800 degrees F. Due to their unique mineralogy, the mineral wool fibers can be used in high temperature applications such as thermal insulation or sound dampening, and are more thermally resistant than glass wool fiber.

In certain illustrative embodiments, the addition of inorganic fibers to the cement composition results in improved mechanical properties in the cement composition. For example, a cement composition with inorganic fibers added thereto can have increased tensile strength when used in subterranean formations.

In an illustrative embodiment, the mineral wool fibers can be largely composed of Al₂O₃ and SiO₂, and possess higher alkaline earth oxide content (Al₂O₃, MgO, and CaO) and lower alkali metal oxide content (Na₂O and K₂O) than glass wool fibers. In another illustrative embodiment, the mineral wool fibers can be largely composed of CaO and SiO₂, and can also contain significant amounts of Al₂O₃, MgO, and Fe₂O₃.

Examples of mineral wool fibers that are useful in the presently disclosed subject matter are MAGMA FIBER® which is commercially available from Lost Circulation Specialists, Inc., of Tomball, Texas, and THERMAFIBER® which is commercially available from Owens Corning (formerly Thermafiber, Inc. of Wabash, Indiana). MAGMA FIBER® is available in a wide range of particle sizes. For example, it is commercially available in a “fine” form having a length of from about 0.1 to about 4 mm and a “regular” form having a length of from about 4 to about 20 mm with an average length of about 10 to about 16 mm. The fiber diameters of both grades of MAGMA FIBER® can range from about 5 to about 15 microns with an average diameter of about 7 to about 10 microns. THERMAFIBER® is available in a wide range of sizes, with diameters ranging from 1.75 microns to 8.65 microns, with an average diameter of 5 microns, and lengths from 0.1 mm to 4.0 mm average.

Mineral wool fibers for use according to the presently disclosed subject matter may optionally be from either “fine” or “regular” form, or from a mixture of these forms as appropriate. In general, mineral wool fibers having a variety of lengths and diameters may be suitable for use with the presently disclosed subject matter. The diameter and length of the mineral wool fibers may be controlled during preparation thereof. In an illustrative embodiment, the appropriate length and diameter of the mineral wool fibers may be selected based on a particular application.

The mineral wool fibers should be present in the cement composition in an amount sufficient to provide the desired properties. For example, mineral wool fibers have been tested and determined to provide improved tensile strength when the cement composition is used within the subterranean formation.

In certain illustrative embodiments, the mineral wool fibers are present in the cement composition of the presently disclosed subject matter in an amount in the range of from about 0.1% to about 10% by weight of cement. In certain illustrative embodiments, the mineral wool fibers are present in an amount in the range of from about 0.5% to about 3% by weight. In certain illustrative embodiments, the mineral wool fibers are present in an amount of 1% by weight.

Other additives suitable for use in operations in subterranean formations also may be added to the cement composition. These other additives can include commonly used oilfield chemicals and combinations thereof. A person having ordinary skill in the art, with the benefit of this disclosure, will know the type and amount of additive useful for a particular application and desired result.

Various methods of treating subterranean formations using a cement composition containing inorganic fibers are also disclosed herein. For example, disclosed herein is a method of cementing an oil and gas well in a subterranean formation. A cement composition is provided comprising water and cement. Inorganic fibers can be added to the cement composition. The cement composition can be injected into the wellbore. Also disclosed herein is a method of enhancing the tensile strength of a cementing composition introduced into a subterranean formation. The cementing composition can comprise water and cement. Inorganic fibers can be added to the cementing composition, and the cementing composition can be introduced into the subterranean formation. In certain illustrative embodiments, the inorganic fibers comprise mineral wool fibers.

To facilitate a better understanding of the presently disclosed subject matter, the following examples of certain aspects of certain embodiments are given. In no way should the following examples be read to limit, or define, the scope of the presently disclosed subject matter.

### EXAMPLES

Experimental test results are shown in Table 1 herein. Addition of 1% (bwoc) of MagmaFiber material to the cement slurry results in ˜15% increase in the compressive strength and tensile strength. A similar addition of 3% fiber (bwoc) to the slurry has a ˜22% increase in the cement compressive strength and a 10% increase in tensile strength. The increase in tensile and/or compressive strength can thus be tuned to the desired level by addition of the materials described in the presently disclosed subject matter.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter. Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

TABLE 1

| | Cement + Additives | | | | | | | | | | | | |
|---|---|---|---|---|---|---|---|---|---|---|---|---|---|
| | | | | | | Disper- | sodium | ligno- | inor- | | | den- | |
| | | | silica | PVOH | HEC | sant | metasilicate | sulfonate | ganic | water | | sity | BHCT |
| Slurry | cement | | % | % | % | % | % | retarder % | fiber % | type | gps | ppg | ° F. |
| 1 | Joppa H | | | 0.44 | | 0.36 | 0.2 | 0.2 | | Fresh | 4.179 | 16.5 | 140 |
| 2 | ″ | | | ″ | | ″ | ″ | ″ | 0.2 | ″ | 4.193 | ″ | ″ |
| 3 | ″ | | | | 0.32 | 0.48 | | | | ″ | 4.492 | 16.2 | ″ |
| 4 | ″ | | | | ″ | ″ | | | 0.2 | ″ | 4.506 | ″ | ″ |
| 5 | ″ | | | | ″ | ″ | | | 0.4 | ″ | 4.52 | ″ | ″ |
| 6 | ″ | | | | ″ | ″ | | | 0.6 | ″ | 4.533 | ″ | ″ |
| 7 | ″ | | 35 | | 0.4 | 0.6 | | | | ″ | 5.574 | ″ | ″ |
| 8 | ″ | | ″ | | ″ | ″ | | | 1 | ″ | 5.644 | ″ | ″ |
| 9 | ″ | | ″ | | ″ | ″ | | | 3 | ″ | 5.783 | ″ | ″ |
| | | | | | | | | | | | | Destructive | |
| | | | | | | | | | | | Fluid | Mechanical | |
| | | | | | | | | | | | Loss | Properties @ | |
| | Rheologies in Fann deg | | | | | | | | | | 30 | 96 hrs. 3000 psi | |
| | Temp | | | | | | | | | | min | C.S. | Tensile |
| Slurry | ° F. | Reading | 600 | 300 | 200 | 100 | 60 | 30 | 6 | 3 | cc | psi | psi |
| 1 | amb | ramp up | | 157 | 119 | 69 | 47 | 30 | 17 | 3(78.8° F.) | 28 | | |
| | | ramp down | 286(76.9° F.) | | 109 | 60 | 39 | 23 | 8 | 7(77.9° F.) | | | |
| | 140 | ramp up | | 62 | 43 | 22 | 14 | 8 | 2 | 1(145.3° F.) | | | |
| | | ramp down | 134(142.6° F.) | | 42 | 22 | 13 | 8 | 3 | 2(144.9° F.) | | | |
| 2 | amb | ramp up | | 186 | 133 | 75 | 51 | 32 | 17 | 15(77.3° F.) | 26 | | |
| | | ramp down | 313(76.2° F.) | | 132 | 72 | 47 | 28 | 10 | 8(76.9° F.) | | | |
| | 140 | ramp up | | 89 | 55 | 27 | 17 | 9 | 2 | 1(144.6° F.) | | | |
| | | ramp down | 114(141.5° F.) | | 58 | 29 | 17 | 9 | 2 | 2(145.1° F.) | | | |
| 3 | amb | ramp up | | 221 | 161 | 101 | 67 | 37 | 9 | 5(71.7° F.) | 76 | | |
| | | ramp down | 423(71.6° F.) | | 173 | 96 | 61 | 33 | 7 | 2(71.5° F.) | | | |
| | 140 | ramp up | | 124 | 86 | 47 | 30 | 16 | 3 | 2(140.2° F.) | | | |
| | | ramp down | 203(138.7° F.) | | 86 | 47 | 29 | 15 | 3 | 2(140.6° F.) | | | |
| 4 | amb | ramp up | | 231 | 168 | 94 | 60 | 32 | 6 | 3(72.6° F.) | 78 | | |
| | | ramp down | 392(772.0° F.) | | 163 | 88 | 55 | 229 | 6 | 3(72.5° F.) | | | |
| | 140 | ramp up | | 93 | 65 | 35 | 21 | 16 | 2 | 1(143.3° F.) | | | |
| | | ramp down | 196(141.3° F.) | | 65 | 334 | 22 | 11 | 2 | 1(141.3° F.) | | | |
| 5 | amb | ramp up | | 247 | 180 | 101 | 65 | 34 | 7 | 4(69.7° F.) | 70 | | |
| | | ramp down | 416(69.8° F.) | | 175 | 95 | 60 | 32 | 7 | 4(70.4° F.) | | | |
| | 140 | ramp up | | 98 | 68 | 36 | 22 | 11 | 2 | 1(144.3° F.) | | | |
| | | ramp down | 216(139.9° F.) | | 68 | 36 | 22 | 11 | 2 | 1(143.7° F.) | | | |
| 6 | amb | ramp up | | 235 | 167 | 98 | 65 | 35 | 8 | 5(72.1° F.) | 70 | | |
| | | ramp down | 411(71.4° F.) | | 168 | 92 | 59 | 32 | 7 | 4(71.7° F.) | | | |
| | 140 | ramp up | | 109 | 74 | 40 | 25 | 14 | 3 | 2(144.3° F.) | | | |
| | | ramp down | 182(138.8° F.) | | 77 | 41 | 26 | 14 | 3 | 2(142.1° F.) | | | |
| 7 | amb | ramp up | | | | | | | | | | 3327 | 464 |
| | | ramp down | | | | | | | | | | | |
| | 140 | ramp up | | | | | | | | | | | |
| | | ramp down | | | | | | | | | | | |
| 8 | amb | ramp up | | | | | | | | | | 3842 | 529 |
| | | ramp down | | | | | | | | | | | |
| | 140 | ramp up | | | | | | | | | | | |
| | | ramp down | | | | | | | | | | | |
| 9 | amb | ramp up | | | | | | | | | | 4067 | 557 |
| | | ramp down | | | | | | | | | | | |
| | 140 | ramp up | | | | | | | | | | | |
| | | ramp down | | | | | | | | | | | |

What is claimed is:

1. A method of cementing an oil and gas well in a subterranean formation, the method comprising:
providing a cementing composition, the cementing composition comprising water, a cement and inorganic fibers;
injecting the cementing composition into the subterranean formation; and
distributing the cementing composition within the subterranean formation.

2. The method of claim 1, wherein the cementing composition has an increased tensile strength after the inorganic fibers are added to the cementing composition.

3. The method of claim 1, wherein the inorganic fibers comprise mineral wool fibers.

4. A method of enhancing the tensile strength of a cementing composition introduced into a subterranean formation, the cementing composition comprising water and a cement, the method comprising:
adding inorganic fibers to the cementing composition; and
introducing the cementing composition into the subterranean formation.

5. The method of claim 4, wherein the inorganic fibers comprise mineral wool fibers.

6. A cement composition for use in a subterranean formation, the cement composition comprising:
water;
cement; and
inorganic fibers.

7. The cement composition of claim 6, wherein the inorganic fibers comprise mineral wool fibers.
